(19) United States
(12) Patent Application Publication
(10) Pub. No.: US 2019/0302067 A1
(43) Pub. Date: Oct. 3, 2019

(54) AUTOMATED TWO-COLUMN RECYCLING CHROMATOGRAPHY METHOD FOR UNLOCKING CHALLENGING SEPARATION PROBLEMS

(71) Applicant: Waters Technologies Corporation, Milford, MA (US)

(72) Inventors: Fabrice Gritti, Franklin, MA (US); Thomas S. McDonald, Littleton, MA (US); Mike Leal, Somerset, MA (US)

(73) Assignee: Waters Technologies Corporation, Milford, MA (US)

(21) Appl. No.: 16/367,566

(22) Filed: Mar. 28, 2019

Related U.S. Application Data
(60) Provisional application No. 62/649,803, filed on Mar. 29, 2018.

(51) Int. Cl. G01N 30/20; G01N 30/30; G01N 30/34

(52) U.S. Cl. CPC G01N 30/20; G01N 30/30; G01N 2030/027; G01N 2030/3007; G01N 30/34

(57) ABSTRACT

The technology relates to a recycling chromatography method. A sampled is injected into a mobile phase flow stream of a liquid chromatography system creating a combined flow stream. The liquid chromatography system includes at least two columns positioned in series, a valve in fluid communication with the at least two columns, and a detection cell positioned between the at least two columns. The combined flow stream is flowed through the at least two columns and chromatographic peaks of the sample are monitored by the detection cell. The detection cell is configured to measure resolution and width of the chromatographic peaks and automatically switch the valve from a first position to a second position when the measured resolution is less than a desired resolution, the measured width is less than a maximum combined peak width, and a switch count is less than a predetermined maximum number of switches.

### CROSS-REFERENCE TO RELATED APPLICATIONS

This application claims benefit of and priority to U.S. provisional patent application No. 62/649,803, filed on Mar. 29, 2018, the entire contents of which is hereby incorporated by reference herein.

### FIELD OF THE TECHNOLOGY

The present disclosure relates to an automated two-column recycling chromatography method and system for unlocking challenging separation problems. In particular, the present disclosure relates to a detection cell that can measure resolution and width of the chromatographic peaks and automatically switch a valve from a first position to a second position when the measured resolution is less than a desired resolution, the measured width is less than a maximum combined peak width, and a switch count is less than a predetermined maximum number of switches.

### BACKGROUND

The full baseline separation of compounds with selectivity factors smaller than 1.05 is extremely challenging or even impossible when using standard high performance liquid chromatography (HPLC) columns that are packed with standard sized particles (e.g., about 3.5 μm) and operated at standard pressure drops (e.g., smaller than about 400 bar). The highest achievable efficiency is that of an infinitely long column run at an infinitely small flow rate. This efficiency limit is fixed by the maximum allowable system pressure, the column permeability, the viscosity of the eluent, and the intensity of the longitudinal diffusivity of the compounds along the column. This limit can only be observed under non-practical experimental conditions for infinitely long columns and elution times.

Alternatively, a two-column recycling separation process (TCRSP) can alleviate this resolution limit by transferring the separation zone from one to another identical column until the spatial width of the zone reaches one column length. Calculations predict that the TCRSP can overcome the classical speed-resolution barrier of a conventional one-column batch process. The performance of TCRSP can be negatively or positively affected by the dependence of the retention factor of the analyte on the local pressure along the column.

One problem with the two-column recycling separation process is that a user has to manually control the switching of a valve that transfers the separation zone from a first column to a second column. This requires constant user involvement in the two-column recycling separation process making the process labor intensive. In addition, the time at which the two columns need to be switched is sensitive to unexpected changes in operating conditions, such as temperature, flow rate, retentivity, and column efficiency. Moreover, each of these variables can change over time, resulting in a loss in efficiency and or resolution with manual valve switching.

### SUMMARY

The present technology solves the problems of the prior art by providing an automated two-column recycling chromatography method for unlocking challenging separation problems. In particular, the present disclosure relates to a detection cell that can measure resolution and width of the chromatographic peaks and automatically switch a valve from a first position to a second position when the measured resolution is less than a desired resolution, the measured width is less than a maximum combined peak width, and a switch count is less than a predetermined maximum number of switches. This can be done through a feedback loop that is incorporated into the detection cell. The feedback loop can be positioned between the detector and valve. The detection cell can include the detector and feedback loop.

The technology provides a method and device that automatically controls the switching of the valve that transfers the separation zone from a first column to a second column based on measured peak data (e.g., peak resolution and width) instead of based on theory and calculations of when the valve should be switched. The technology can accurately take into account how the peak resolution and width is changing over time due to unexpected changes in operating conditions (e.g., temperature, flow rate, retentivity, and column efficiency) that cannot be taken into consideration effectively using prior art methods and devices.

The present disclosure relates to a recycling chromatography method. The method includes injecting a sample into a mobile phase flow stream of a liquid chromatography system to create a combined flow stream. The liquid chromatography system includes at least two chromatographic columns positioned in series, a valve in fluid communication with the at least two chromatographic columns, and a detection cell positioned between the at least two chromatographic columns. The method also includes flowing the combined flow stream through the at least two chromatographic columns and monitoring chromatographic peaks of the sample by the detection cell. The detection cell is configured to measure resolution and width of the chromatographic peaks and automatically switch the valve from a first position to a second position when the measured resolution is less than a desired resolution, the measured width is less than a maximum combined peak width, and a switch count is less than a predetermined maximum number of switches.

The method can include one or more of the embodiments described herein. The detection cell can be configured to calculate a switch time and automatically switch the valve from the first position to the second position at the calculated switch time. In some embodiments, the detection cell continues to monitor the chromatographic peaks of the sample and switch the valve from the first position to the second position or the second position to the first position until a) the measured resolution is greater than the desired resolution; b) the measured combined peak width is greater than or equal to the maximum combined peak width; or c) the switch count is greater than or equal to the predetermined maximum number of switches.

The method can also include detecting the combined flow stream. In some embodiments, the method includes calculating an elution time for each peak.

The detection cell can be a low dispersion detection cell.

In some embodiments, the at least two chromatographic columns are identical.

The valve is a six-port or an eight-port valve. In some embodiments, the valve is a ten-port valve. The valve can be a low-dispersion valve, which can provide a two-fold gain in final peak resolution for the recycling chromatography method relative to a standard commercial valve.

The technology provides a chromatography system. The system includes an injector for injecting a sample into a mobile phase flow stream creating a combined flow stream. The system also includes at least two chromatographic columns positioned in series and downstream of the injector and a valve in fluid communication with the at least two chromatographic columns. A detection cell is positioned between the at least two chromatographic columns. The detection cell is configured to monitor chromatographic peaks of the sample, measure resolution and width of the chromatographic peaks, and automatically switch the valve from a first position to a second position when the measured resolution is less than a desired resolution, the measured width is less than a maximum combined peak width, and a switch count is less than a predetermined maximum number of switches. The system also includes a detector downstream of the at least two chromatographic columns.

The system can include one or more of the embodiments described herein. The detection cell can be further configured to calculate a switch time and automatically switch the valve from the first position to the second position at the calculated switch time. In some embodiments, the detection cell is a low dispersion detection cell.

The at least two chromatographic columns can be identical. The at least two chromatography columns can be liquid chromatographic columns.

In some embodiments, the valve is a six-port valve. The valve can be an eight-port valve for a ten-port valve.

The embodiments of the present disclosure provide advantages over the prior art by automatically controlling the switching of the valve that transfers the separation zone from a first column to a second column based on measured peak data instead of relying on predetermined switching times that were based on calculated peak resolutions and widths. The pre-calculated switching times cannot take into account changes in operating conditions. The present technology can accurately take into account any fluctuations in operating conditions in real-time based on measured, real-time peak data instead of pre-determined switching times based on theory and calculation.

The technology enables users to solve exceptionally hard separation problems under isocratic conditions (selectivity factor α<1.05) with standard HPLC columns, which cannot alone achieve full separation. Chiral compounds, impurities from API, isomers, isotopes, and monoclonal antibodies and their aggregates can be separated and are direct applications of this technology. A benefit of the technology is that a user does not have to control manually the switching valve timing, which is sensitive to unexpected changes in operating conditions such as temperature, flow rate, retentivity, and column efficiency that can change in real-time.

### BRIEF DESCRIPTION OF THE DRAWINGS

The technology will be more fully understood from the following detailed description taken in conjunction with the accompanying drawings, in which:

FIG. 1A is a schematic representation of a two-column recycling chromatography system using an external ten-port valve in Position A, according to an illustrative embodiment of the technology.

FIG. 1B is a schematic representation of a two-column recycling chromatography system using an external ten-port valve in Position B, according to an illustrative embodiment of the technology.

FIG. 2 is a flow chart of the logic used by the feedback loop incorporated into the detection cell, according to an illustrative embodiment of the technology.

### DETAILED DESCRIPTION

The technology is based on the design of a new instrumentation and method to be used in chromatography systems, for example, liquid chromatography or gas chromatography. The system includes an injector, two identical or nearly identical chromatographic columns, a valve having 6, 8, or 10 ports, and a detector, for example, a low dispersion detector. The compounds are separated through a virtual semi-infinitely long column by transferring at the time the valve switches the sample zone from one column to a second column (and vice versa) until the width of the separation zone becomes equal to one column length.

The two-column recycling system and process includes a valve switch that allows for the automatic switching of the valve and automatic termination of the process. This is controlled by a feedback answer provided by a detection cell, for example, a low dispersion detection cell, placed in series between the two chromatographic columns. The technology allows exceptionally hard separation problems under isocratic conditions (selectivity factor α<1.05) with standard HPLC columns to be solved. Chiral compounds, impurities from active pharmaceutical ingredients (API), isomers, isotopes, and monoclonal antibodies and their aggregates can be separated and are direct applications of this technology. A benefit of the technology is that a user does not have to control manually the switching valve timing, which is sensitive to unexpected changes in operating conditions such as temperature, flow rate, retentivity, and column efficiency that can change in real-time. In addition, the technology can provide a lower limit of detection than can be provided at the column outlet.

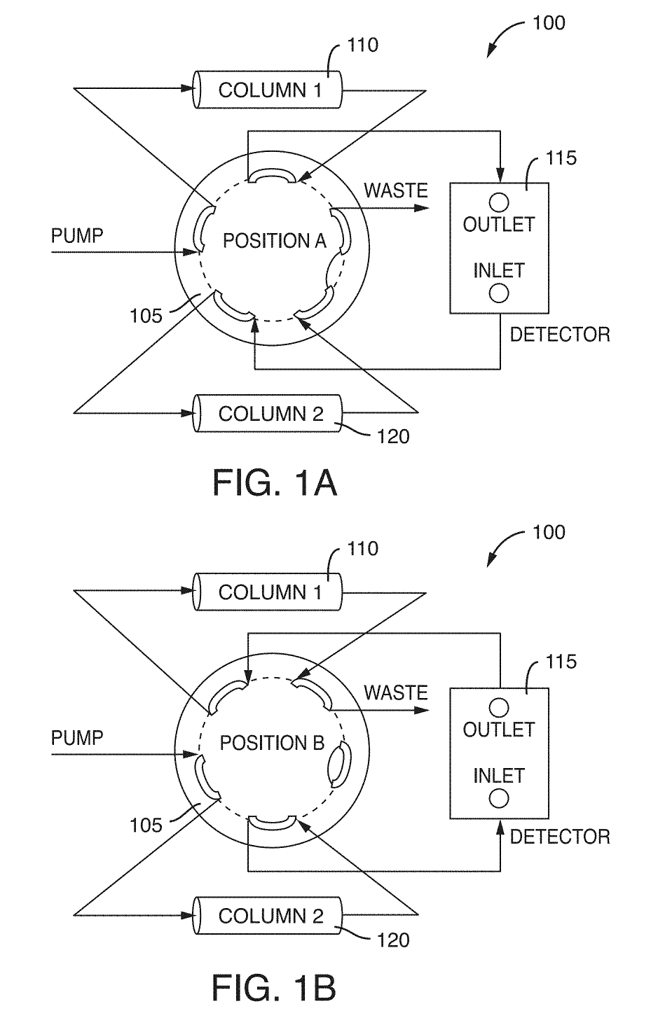

FIG. 1A is a schematic representation of a two-column recycling chromatography system 100 using an external ten-port valve in Position A and FIG. 1B is a schematic representation of a two-column recycling chromatography system 100 using an external ten-port valve in Position B. The system includes an injector (not shown) that injects a sample into a mobile phase flow stream creating a combined flow stream. The system also includes a valve 105. The valve 105 can have 6 ports, 8 ports, or 10 ports.

The system can also include at least two chromatographic columns, for example first column 110 and second column 120. The first column 110 and the second column 120 can be identical. In some embodiments, the first column 110 and the second column 120 are nearly identical. The two chromatography columns 110, 120 are positioned in series. The first column 110 and the second column 120 can be liquid chromatography columns or gas chromatography columns. The two columns 110, 120 can be high performance chromatography columns. The two columns 110, 120 can be stainless steel. In some embodiments, more than two columns are used, for example, three or four columns. The column length, internal diameter, packing material, and flow rate can be chosen based on the specific sample and separation being performed. Similarly, the column efficiency, retention factor, and selectivity factor can be based on the specific sample and separation being performed. One of ordinary skill in the art understands how to choose these column parameters based on the sample to be separated.

The sample dispersion, or band spreading, can be kept to a minimum by minimizing the distance between the components (e.g., columns, valves, detector, tubing). For example, the distance between the components can be between about 10 cm to about 20 cm. In some embodiments, the distance between the components can be about 15 cm. In some embodiments, the distance between the valve and the columns inlets is about 14 cm, 13 cm, 12 cm, 11 cm, or 10 cm. As an example, the distance between the valve and the column inlets and outlets can be about 15 cm. This allows the use of a low-dispersion face seal 75 μm×25 cm long connecting tubes with minimum sample dispersion less than about 0.1 μL². ZenFit® connection technology commercially available from Waters Corporation, Milford, Mass. can be use as the connecting tubes. By keeping the distance between each component minimal, band spreading that occurs outside of the columns can also be minimized.

A detector/detection cell 115 is positioned between the first column 110 and the second column 120. The detection cell 115 can be a low dispersion detection cell to keep the any extra-column band broadening attributable to the detection cell small. The detection cell can be, for example, a UV detection cell or a fluorescence detector.

Referring to FIG. 1A, a sample and mobile phase combined flow stream are flowed through a valve 105 in Position A and into a first column 110 where at least a portion of the sample is separated. The mobile phase composition is chosen based on the specific separation to be achieved, the specific sample that is being separated, and/or whether the chromatography columns are liquid chromatography columns or gas chromatography columns.

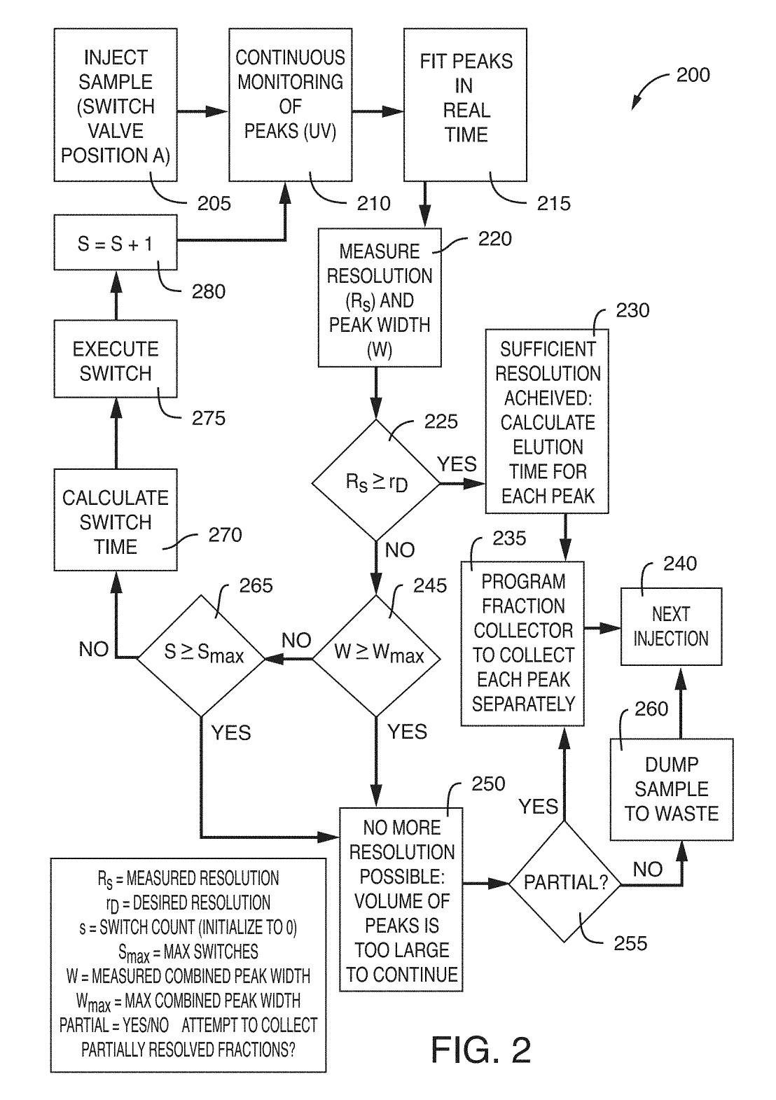

The partially separated combined flow stream then flows out of the first column 110 and through valve 105 to a detector 115. The detector 115 automatically determines, based on a detected/measured peak resolution and width, and switches the valve 105 from Position A to Position B when the measured resolution is less than a desired resolution, the measured width is less than a maximum combined peak width, and a switch count is less than a predetermined maximum number of switches. The method used by the detector 115 is shown in FIG. 2 and can be incorporated into the detection cell 115 through the use of a feedback loop. In some embodiments, the feedback loop is not incorporated into the detection cell, but is incorporated into an electronic component that is positioned after the detection cell and before the valve.

Still referring to FIG. 1A, the partially separated combined flow stream exits the detector 115, flows through valve 105 and into a second column 120 where the sample is further separated. The further separated combined flow stream exits the second column 120 and flows through valve 105. If the detector 115 has determined (i.e., through the feedback loop) that the measured resolution was greater than a desired resolution, a measured width was greater than or equal to a maximum combined peak width or that a switch count was greater than or equal to a predetermined maximum number of switches based on the separation that occurred in the first column 110, then the valve 105 remains in Position A and the combined flow stream flows out of the valve 105 to waste. In some embodiments, the combined flow stream does not go to waste but instead flows to a further detector (not shown) that is downstream of the at least two chromatographic column. Further detection and analysis can be performed on the separated sample by the additional detector. The detector can be, for example, a UV detection cell or a fluorescence detector.

However, if the feedback loop incorporated into the detector 115 has determined that based on a detected/measured peak resolution and width that the measured resolution is less than a desired resolution, the measured width is less than a maximum combined peak width, and a switch count is less than a predetermined maximum number of switches, then the detector through the self-controlled feed-back loop, will automatically switch the valve 105 from Position A in FIG. 1A to Position B in FIG. 1B. The valve 105 is switched prior to the combined flow stream entering the valve 105 after exiting the second column 120.

When the valve is switched to Position B in FIG. 1B, the sample and mobile phase exit the second column 120, enter the valve 105 and flow to the detector 115. The flow exits the detector 115, flows into the valve 105 and then into the first column 110. If the feedback loop incorporated into the detector 115 determines that the measured resolution is greater than a desired resolution, a measured width is greater than or equal to a maximum combined peak width or that a switch count is greater than a predetermined maximum number of switches based on the separation that occurred in the second column 120, then the valve 105 remains in Position B and the combined flow stream flows out of the valve 105 to waste. As described above, in some embodiments, the combined flow stream does not flow to waste and instead flows to a detector for further analysis of the sample.

However, if the feedback loop incorporated into the detector 115 determines that based on a detected/measured peak resolution and width that the measured resolution is less than a desired resolution, the measured width is less than a maximum combined peak width, and a switch count is less than a predetermined maximum number of switches, then the detector, through the feedback loop, will automatically switch the valve 105 from Position B in FIG. 1B to Position A in FIG. 1A. The valve is switched prior to the sample and mobile phase entering the valve 105 after exiting the first column 110.

When the valve is switched from Position B in FIG. 1B to Position A in FIG. 1A, the sample and mobile phase flow out of the first column 110 into the valve 105 and to the detector 115. The flow continues as was previously described for flow of the sample and mobile phase with the valve 105 in Position A. The flow of the combined flow stream continues in this manner until the detector 115 determines that the measured resolution is greater than a desired resolution, a measured width is greater than or equal to a maximum combined peak width or that a switch count is greater than a predetermined maximum number of switches at which point the detector automatically stops switching valve 115 and the sample and mobile phase flow to waste.

Each time the sample and mobile phase flow through the first column 110 and the second column 120, the sample is further separated. In this way, the continuous separation of the sample through the two columns mimics an infinitely long column.

FIG. 2 shows a flow chart 200 of the logic used by the feedback loop incorporated into the detection cell to determine whether the detection cell should automatically switch the position of a valve, e.g., valve 115 of FIGS. 1A-B. The process begins by injecting a sample (step 205) into a mobile phase flow stream of a chromatography system, for example, a liquid chromatography or gas chromatography system, creating a combined flow stream. If the valve (as described in FIGS. 1A and 1B) is not already in Position A, then the valve is switched to Position A. As the combined flow stream flows through the chromatography columns and detection cell, the detection cell continuously monitors the peaks, for example, by UV detection (step 210). The detection cell fits the peaks in real time (step 215) and measures the resolution (Rₛ) and the peak width (w) (step 220) of the separated sample.

The feedback loop incorporated into the detection cell then makes a first determination based on the measurements and calculations of the detector. The first determination is whether the measured resolution (Rₛ) is greater than a desired resolution (r_{D}) (step 225). The desired resolution (r_{D}) is a resolution value that has been pre-determined by the user as being a sufficient resolution for the separation of the sample. If it is determined that the measured resolution (Rₛ) is greater than a desired resolution (r_{D}) (step 225), then sufficient resolution has been achieved and the detection cell can calculate the elution time for each peak that has been separated from the sample (step 230). A program fraction collector can collect each peak separately (step 235) and the method has been completed. A new sample can then be injected (step 240) and the process can start again. In some embodiments, the method includes detecting the combined flow stream by a detector that is located downstream of the at least two chromatographic columns. The detector can be, for example, a UV detection cell or a fluorescence detector.

If, the measured resolution (Rₛ) is less than a desired resolution (r_{D}) (step 225), the feedback loop incorporated into the detection cell determines whether the measured combined peak width (w) is greater than or equal to a maximum combined peak width (wₘₐₓ) (step 245). The maximum combined peak width is a predetermined maximum based on the specific sample that is being separated. In other words, the detector records the time at which the separation zone is fully eluted from the first column and sends a command to the valve to actuate at that moment in time. The same feedback control is repeated and ends when the front part of the sample zone is leaving one column which the rear part of the sample zone is still eluting from another column.

If the measured combined peak width (w) is greater than or equal to a maximum combined peak width (wₘₐₓ) (step 245), then no more resolution of the peaks in possible and the volume of peaks is too large to continue (step 250). A data processor in a feedback loop that can be incorporated into the detector determines whether a partial separation of the peaks can be collected (step 255). If a partial separation of the peaks can be collected (step 255), then the program fraction collection can collect each partially separated peak (step 235), a new sample can be injected (step 240) and the process can start again. If a partial separation of the peaks cannot be collected (step 255), the sample is dumped to waste (step 260), a new sample can be injected (step 240) and the process can start again.

If, the measured resolution (Rₛ) is less than a desired resolution (r_{D}) (step 225) and the measured combined peak width (w) is less than a maximum combined peak width (wₘₐₓ) (step 245), then the feedback loop incorporated into the detection cell (for example, detection cell 115 of FIGS. 1A and 1B) determines whether the switch count (s) is greater than or equal to a predetermined maximum number of switches (sₘₐₓ) (step 265). The predetermined maximum number of switches is determined based on the specific sample to be separated. If the switch count (s) is greater than or equal to a predetermined maximum number of switches (sₘₐₓ) (step 265), then no more resolution of the peaks in possible and the volume of peaks is too large to continue (step 250). A data processor in a feedback loop that can be incorporated into the detector determines whether a partial separation of the peaks can be collected (step 255). If a partial separation of the peaks can be collected (step 255), then the program fraction collection can collect each partially separated peak (step 235), a new sample can be injected (step 240) and the process can start again. If a partial separation of the peaks cannot be collected (step 255), the sample is dumped to waste (step 260), a new sample can be injected (step 240) and the process can start again.

If the feedback loop incorporated into the detection cell (for example, detector cell 115 of FIGS. 1A and 1B) determines that (1) the measured resolution (Rₛ) is less than a desired resolution (r_{D}) (step 225); (2) the measured combined peak width (w) is less than a maximum combined peak width (wₘₐₓ) (step 245); and (3) the switch count (s) is less than a predetermined maximum number of switches (sₘₐₓ) (step 265), then the switch time is calculated (step 270). The switch time is the time at which the detection cell will switch the valve from Position A to Position B or vice versa (see, e.g., FIGS. 1A and 1B). The detection cell will then execute the switch (step 275) at the calculated time by switching the valve from Position A to Position B or from Position B to Position A. The switch count (s), which was initialized at zero, is then increased by one (s=s+1) (step 280). The process then repeats with the continuation monitoring of the peaks (step 210), fitting the peaks in real time (step 215), and measuring the resolution and peak width (step 220) to determine whether the results of the separation are sufficient (step 230), no more resolution is possible (step 250) or whether the process needs to repeat again (steps 270, 275, 280).

It should be noted that the particular numbering of the steps of the process 200 is not intended to imply that the process occurs serially or in any particular order. For example, the feedback loop can determine whether (1) the measured resolution (Rₛ) is less than a desired resolution (r_{D}) (step 225); (2) the measured combined peak width (w) is less than a maximum combined peak width (wₘₐₓ) (step 245); and (3) the switch count (s) is less than a predetermined maximum number of switches (sₘₐₓ) (step 265), simultaneously. In some embodiments, two steps can be performed simultaneously and then the third step can be performed. Additionally, the steps can be performed in any order, for example step 245 can be performed first, then step 225, then step 265. Alternatively, step 265 can be performed first, then step 245, then step 225. In some embodiments, the algorithm only includes two out of the three steps, for example, the algorithm can include steps 225 and 245, or steps 245 and 265, or steps 225 and 265.

The feedback loop can be in communication with a controller that controls the position of the valve. The controller can be located in the detection cell or the controller can be located with the circuitry (e.g., a microprocessor) of the feedback loop that is housed in a separate component from the detector cell (e.g., in a component located between the detector cell and the valve). The controller can be in communication with the feedback loop, the valve, and/or the detection cell.

In some embodiments, a computer is coupled to the output of the detection cell. The computer can have code executing thereof, which, when executed, causes the computer perform the recycling chromatography method described herein, e.g., monitoring chromatographic peaks of the sample as output by the detection cell, measuring resolution and width of the chromatographic peaks, and causing a controller to automatically switch the valve from a first position to a second position when the measured resolution is less than a desired resolution, the measured width is less than a maximum combined peak width, and a switch count is less than a predetermined maximum number of switches. In some embodiments, the computer can store the data in memory.

In some embodiments, a non-transitory computer readable medium can include code stored thereof for executing the recycling chromatography method described herein.

Those skilled in the art will recognize, or be able to ascertain using no more than routine experimentation, numerous equivalents to the specific procedures described herein. Such equivalents were considered to be within the scope of this technology and are covered by the following claims. The contents of all references, issued patents, and published patent applications cited throughout this application are hereby incorporated by reference.

What is claimed is:

1. A recycling chromatography method comprising the steps of:
injecting a sample into a mobile phase flow stream of a liquid chromatography system to create a combined flow stream; the liquid chromatography system comprising:
at least two chromatographic columns positioned in series;
a valve in fluid communication with the at least two chromatographic columns; and
a detection cell positioned between the at least two chromatographic columns;
flowing the combined flow stream through the at least two chromatographic columns; and
monitoring chromatographic peaks of the sample by the detection cell, the detection cell configured to measure resolution and width of the chromatographic peaks and automatically switch the valve from a first position to a second position when the measured resolution is less than a desired resolution, the measured width is less than a maximum combined peak width, and a switch count is less than a predetermined maximum number of switches.

2. The recycling chromatography method of claim 1, wherein the detection cell is configured to calculate a switch time and automatically switch the valve from the first position to the second position at the calculated switch time.

3. The recycling chromatography method of claim 1, wherein the detection cell continues to monitor the chromatographic peaks of the sample and switch the valve from the first position to the second position or the second position to the first position until
a) the measured resolution is greater than the desired resolution;
b) the measured combined peak width is greater than or equal to the maximum combined peak width; or
c) the switch count is greater than or equal to the predetermined maximum number of switches.

4. The recycling chromatography method of claim 3, further comprising detecting the combined flow stream.

5. The recycling chromatography method of claim 3, further comprising calculating an elution time for each peak.

6. The recycling chromatography method of claim 1, wherein the detection cell is a low dispersion detection cell.

7. The recycling chromatography method of claim 1, wherein the at least two chromatographic columns are identical.

8. The recycling chromatography method of claim 1, wherein the valve is a six-port or an eight-port valve.

9. A chromatography system comprising:
an injector for injecting a sample into a mobile phase flow stream creating a combined flow stream;
at least two chromatographic columns positioned in series and downstream of the injector;
a valve in fluid communication with the at least two chromatographic columns;
a detection cell positioned between the at least two chromatographic columns, the detection cell configured to:
monitor chromatographic peaks of the sample;
measure resolution and width of the chromatographic peaks; and
automatically switch the valve from a first position to a second position when the measured resolution is less than a desired resolution, the measured width is less than a maximum combined peak width, and a switch count is less than a predetermined maximum number of switches; and
a detector downstream of the at least two chromatographic columns.

10. The chromatography system of claim 9, wherein the detection cell is further configured to calculate a switch time and automatically switch the valve from the first position to the second position at the calculated switch time.

11. The chromatography system of claim 9, wherein the detection cell is a low dispersion detection cell.

12. The chromatography system of claim 9, wherein the at least two chromatographic columns are identical.

13. The chromatography system of claim 9, wherein the valve is a six-port or an eight-port valve.

14. The chromatography system of claim 9, wherein the at least two chromatographic columns are liquid chromatographic columns.
